(19) United States
(12) Patent Application Publication
(10) Pub. No.: US 2007/0029919 A1
(43) Pub. Date: Feb. 8, 2007

(54) Electron emission device having a focus electrode and a fabrication method therefor

(76) Inventor: Sang Jin Lee, Suwon (KR)

Correspondence Address: CHRISTIE, PARKER & HALE, LLP, PO BOX 7068, PASADENA, CA, 91109-7068, US

(21) Appl. No.: 11/472,110

(22) Filed: Jun. 20, 2006

(30) Foreign Application Priority Data
Jul. 22, 2005 (KR) 10-2005-0067005

(51) Int. Cl. H01J 63/04; H01J 1/62

(52) U.S. Cl. 313/495; 313/497

(57) ABSTRACT

An electron emission device includes a cathode electrode formed by depositing a conductive substance on a substrate; a first insulating layer formed to expose a portion of the cathode electrode by applying an insulating substance on the cathode electrode; a gate electrode formed by depositing a metal substance on the first insulating layer; a second insulating layer formed of an insulating substance on the gate electrode; a first focus electrode formed of a metal substance on the second insulating layer; a third insulating layer formed of an insulating substance on a region of the first focus electrode; a second focus electrode formed of a metal substance on the third insulating layer; and an electron emitter formed in a region on which the portion of the cathode electrode is exposed.

### CROSS-REFERENCE TO RELATED APPLICATIONS

This application claims the benefit of and priority to Korean Patent Application No. 10-2005-67005, filed on Jul. 22, 2005, in the Korean Intellectual Property Office, the entire content of which is incorporated herein by reference.

### BACKGROUND

FIG. 1 is a schematic view illustrating a hole-to-slit structure of one embodiment of an electron emission device according to prior art. The electron emission device 10 includes a cathode electrode 12 formed by depositing a conductive substance on a substrate 11; a first insulating layer 13 formed to expose a portion of the cathode electrode 12 by applying an insulating substance on the cathode electrode 12; a gate electrode 14 formed by depositing a metal substance on the first insulating layer 13; a second insulating layer 15 formed of an insulating substance on a predetermined region of the gate electrode 14; a focus electrode 16 formed of a metal substance on the second insulating layer 15; and an electron emitter 17 formed in a region 18 on which the portion of the cathode electrode 12 is exposed.

The second insulating layer 15 is pattered to remain only on an edge of a sub-pixel region formed with the electron emitter 17 through a photoresist process after applying an insulating substance on the substrate 11 formed with the gate electrode 14. In other words, the foregoing structure is a structure in which a plurality of electron emitters 17 are formed on one sub-pixel region and the second insulating layer 15 is formed on the edge region in which the electron emitters are formed. On the second insulating layer 15, the focus electrode formed of a metal substance is formed. The focus electrode 16 is not formed on the respective electron emitters 17 and has a hole-to-slit structure formed in one sub-pixel unit.

FIG. 2 is a schematic view illustrating a hole-to-hole structure of another embodiment of an electron emission device according to prior art. The electron emission device 20 includes a cathode electrode 22 formed by depositing a conductive substance on a substrate 21; a first insulating layer 23 formed to expose a portion of the cathode electrode 22 by applying an insulating substance on the cathode electrode 22; a gate electrode 24 formed by depositing a metal substance on the first insulating layer 23; a second insulating layer 25 formed of an insulating substance on the gate electrode 24; a focus electrode 26 formed of a metal substance on the second insulating layer 25; and an electron emitter 27 formed in a region 28 on which the portion of the cathode electrode 22 is exposed.

The second insulating layer 25 and the focus electrode 26 are formed in a hole-to-hole structure formed in the respective electron emitters 27.

The electron emission device in FIG. 1 emits a large amount of electrons. However, it has a problem in that horizontal and vertical beam spots emitted from the electron emitter are large.

Furthermore, the electron emission device in FIG. 2 has a problem in that, since it is not assured to have a sufficient thickness of an insulating layer, it applies a negative voltage to the focus electrode in order to shield an electric field from an anode. This results in rapidly reducing the emission amount of electrons.

### SUMMARY

An electron emission device includes a cathode electrode formed by depositing a conductive substance on a substrate; a first insulating layer formed to expose a portion of the cathode electrode by applying an insulating substance on the cathode electrode; a gate electrode formed by depositing a metal substance on the first insulating layer; a second insulating layer formed of an insulating substance on the gate electrode; a first focus electrode formed of a metal substance on the second insulating layer; a third insulating layer formed of an insulating substance on a region of the first focus electrode; a second focus electrode formed of a metal substance on the third insulating layer; and an electron emitter formed in a region on which the portion of the cathode electrode is exposed.

In one embodiment, the region of the first focus electrode on which the third insulating layer is formed is predetermined. The first focus electrode may be formed in a hole-to-hole structure and the second focus electrode may be formed in a hole-to-slit structure.

A voltage at the first focus electrode may be 0V or more to control a focusing of electrons and horizontal and vertical beam spots that are emitted from the electron emitter, and a voltage at the second focus electrode may be 0V or less to control a shield of an electric field from an anode and horizontal or vertical beam spots emitted from the electron emitter.

A fabrication method of an electron emission device having a focus electrode includes forming a cathode electrode on a substrate; forming a first insulating layer by applying an insulating substance on the cathode electrode after forming the cathode electrode on the substrate; forming a gate electrode on the first insulating layer; forming a second insulating layer by applying an insulating substance on the gate electrode after forming the gate electrode on the first insulating layer; forming a first focus electrode on the second insulating layer; forming a third insulating layer and a second focus electrode in a predetermined region after forming the first focus electrode on the second insulating layer; forming a hole in the first insulating layer to expose a portion of the cathode electrode in a region; and forming an electron emitter in the region in which the cathode electrode is exposed.

### BRIEF DESCRIPTION OF THE DRAWINGS

These and/or other aspects and features of the invention will become apparent and more readily appreciated from the following description of examples of embodiments, taken in conjunction with the accompanying drawings of which:

FIG. 1 is a schematic view illustrating a hole-to-slit structure of an electron emission device according to prior art.

FIG. 2 is a schematic view illustrating a hole-to-hole structure of an electron emission device according to prior art.

FIG. 3 is a schematic view illustrating an embodiment of an electron emission device structure having a focus electrode according to the present invention.

FIG. 4A to 4A are process flow diagrams illustrating one embodiment of a fabrication method of an electron emission device according to the present invention.

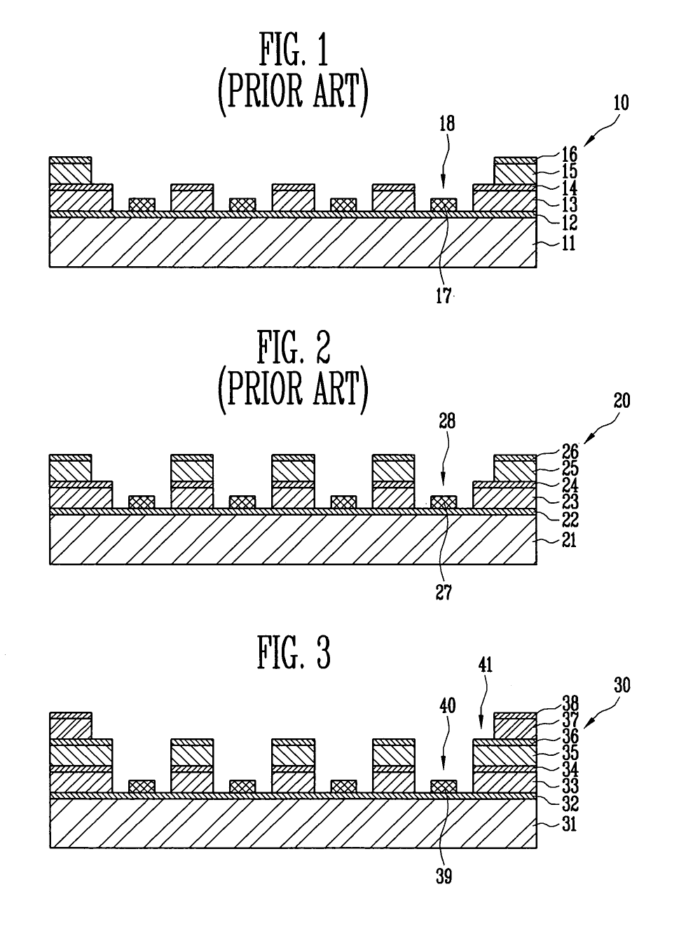

### DETAILED DESCRIPTION

Hereinafter, examples of embodiments of the present invention will be described in a more detail with reference to the accompanying drawings.

FIG. 3 is a schematic view illustrating an electron emission device structure having a focus electrode in one embodiment according to the present invention. As illustrated in FIG. 3, the electron emission device 30 having a focus electrode structure according to the present embodiment includes a cathode electrode 32 formed by depositing a conductive substance on a substrate 31; a first insulating layer 33 formed to expose a portion of the cathode electrode by applying an insulating substance on the cathode electrode 32; a gate electrode 34 formed by depositing a metal substance on the first insulating layer 33; a second insulating layer 35 formed of an insulating substance on the gate electrode 34; a first focus electrode 36 formed of a metal substance on the second insulating layer 35; a third insulating layer 37 formed of an insulating substance on a predetermined region of the first focus electrode 36; a second focus electrode 38 formed of a metal substance on the third insulating layer 37; and an electron emitter 39 formed in a region 40 on which the portion of the cathode electrode 32 is exposed.

The substrate 31 may be, for example, a glass substrate or a silicon substrate. However, in one embodiment, the substrate is formed by rear exposure using a Carbon Nano Tube (CNT) paste as the electron emitter 39, and the substrate is a transparent substrate, such as the glass substrate.

The cathode electrode 32 can be formed on a rear substrate at a predetermined interval and in a pad form. The cathode electrode 32 is supplied with a data signal or a scan signal applied from a data driver or a scan driver, respectively. The cathode electrode 32 may be a conductor, for example, a transparent conductor made of indium tin oxide (ITO).

The first insulating layer 33 is formed on the upper side of the substrate 31 and the cathode electrode 32 and insulates the cathode electrode 32 from the gate electrode 34. The first insulating layer 33 may be formed of an insulating substance, for example, mixing glasses such as PbO and SiO₂, etc.

The gate electrode 34 is disposed on the first insulating layer 33 in a predetermined form, for example, a stripe form in a direction intersecting with a direction of the cathode electrode 32, and is supplied with the data signal and the scan signal applied from the data driver and the scan driver, respectively.

The gate electrode 34 may be formed of metal having a good conductivity, for example, at least one conductive metal substance selected from Ag, Mo, Al, Cr or alloys thereof.

The second insulating layer 35 is formed on the gate electrode 34 and is electrically insulated from the first focus electrode 36. Here, the insulating substance of the second insulating layer 35 may be formed of the same substances as the first insulating material 33.

The first focus electrode 36 is formed on the second insulating layer 35 and is formed of the same metal substances as the gate electrode 34. Here, the first focus electrode 36 is applied with voltage of 0V or more so that it controls primary horizontal and vertical beam spots while also assuring the emission amount of electrons to facilitate a focusing of electrons emitted from the electron emitter 39.

The third insulating layer 37 is formed in a predetermined region on the first focus electrode 36 so that it can assure its own thickness for the focusing of electrons emitted from the electron emitter 39. In other words, the third insulating layer 37 is positioned only on an edge of a sub-pixel region in which the electron emitter 39 is formed. Here, on one sub-pixel region, a plurality of electron emitters 39 are formed.

The second focus electrode 38 is formed of a metal substance on the third insulating layer 37. The second focus electrode 38 is a hole-to-slit structure, which is not formed on each electron emitter and is formed in one sub-pixel unit. The second focus electrode 38 is applied with a voltage of 0V or below so that it controls the shield of electric field from the anode (not illustrated) and secondary horizontal or vertical beam spots emitted from the electron emitter 39.

The electron emitter 39 is located on the exposed cathode electrode 32 to be electrically connected with it. The electron emitter may be formed of carbon nano tubes; nano tubes made of graphite, diamond, diamond-like carbon or combinations thereof; or nano wires made of Si or SiC.

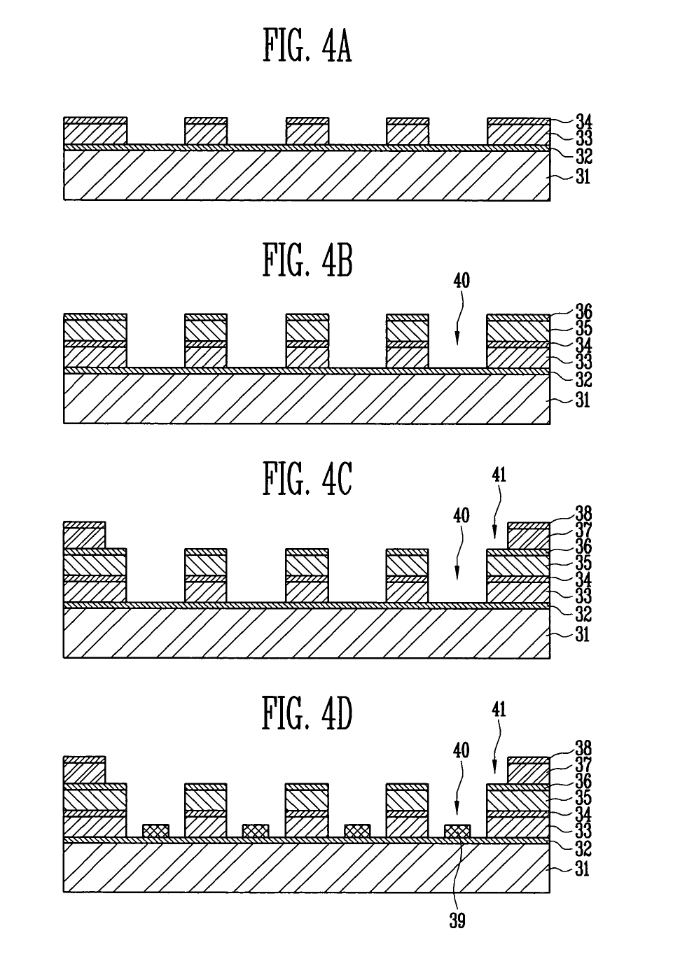

FIG. 4A to 4D are process flow diagrams illustrating one embodiment of a fabrication method of an electron emission device according to the embodiment shown in FIG. 3.

Generally, the electron emission device can be fabricated by a thick film process or a thin film process. The thick film process can be described as a process for forming an insulating layer with a greater thickness by applying an insulating substance in a paste state using a screen printing method. The thin film process can be described as a process for forming an insulating layer with a smaller thickness by depositing an insulating film such as a silicon oxide film using a chemical vapor deposition (CVD) method. The thick film process has the advantages of easy fabrication capability for a large area display device in mass production and of lower production cost; however, it has the disadvantage that it is difficult to fabricate an electron emission device with a fine and high degree of integration.

The thin film process has opposing advantages and disadvantages to those of the thick film process. As illustrated in FIG. 4A, on the substrate 31, the cathode electrode 32, the first insulating layer 33, and the gate electrode 34 are formed. Here, a transparent glass for rear exposure is used as the substrate, as will be described later. The cathode electrode 32 is formed of indium tin oxide (ITO), which is a conductive transparent substance, as described above.

More specifically, ITO is deposited on the substrate 31 at a predetermined thickness of 800 Å to 2000 Å (0.08 μm to 0.2 μm), for example, and is patterned in a predetermined form, for example, a stripe form. The patterning of the cathode electrode 32 can be performed by a well known patterning method of a substance layer, such as a formation of an etching mask by applying, exposing, and developing a photoresist and etching the cathode electrode 32 using the etching mask.

The first insulating layer 33 is formed on the entire surface of the cathode electrode 32 and the substrate 31. In the case of forming the first insulating layer 33 by the thick film process, the first insulating layer 33 having the thickness of approximately 10 μm to 12 μm is formed by applying insulating substance in a paste state at a predetermined thickness by the screen printing method and then burning it at the temperature of approximately 500° C. or more. At this time, the burning temperature can be varied depending on the kinds of insulating substances used. In the case of forming the first insulating layer 33 by the thin film process, the first insulating layer 33 is formed by depositing an insulating film such as a silicon oxide film at the thickness of approximately 1 μm to 1.5 μm by the chemical vapor deposition method.

Next, on the first insulating layer 33 the gate electrode 34 is formed. The gate electrode 34 is deposited with a conductive metal, for example, at least one conductive metal substance selected from Ag, Mo, Al, Cr or alloys thereof at the thickness of approximately 2500 Å to 3000 Å (0.25 μm to 0.30 μm) by a sputtering method.

Subsequently, as illustrated in FIG. 4B, the second insulating layer 35 and the first focus electrode 36 are sequentially stacked on the first insulating layer 33 and the gate electrode 34. The second insulating layer 35 can be formed by the same forming method as the first insulating layer 33. However, in the case of forming the second insulating layer 35 by the thick film process, it is formed to have a thickness of approximately 30 μm to 40 μm, and in the case of forming the second insulating layer by the thin film process, it is formed to have a thickness of approximately 1 μm to 1.5 μm.

The first focus electrode 36 is formed on the second insulating layer 35. Specifically, the first focus electrode 36 is formed by depositing a conductive metal, for example, one of Ag, Mo, Al, Cr or alloys thereof at the thickness of approximately 2500 Å to 3000 Å (0.25 μm to 0.30 μm) on the second insulating layer 35 by the sputtering method. Here, the first focus electrode 36 facilitates a focusing of electrons emitted from the electron emitter to be formed later. At this time, a hole 40 is formed by patterning the first focus electrode 36 and the second insulating layer 35. Here, the hole is formed by applying and patterning a photoresist PR on an upper portion of the stack structure and then etching a portion of the first focus electrode 36 and the second insulating layer 35. In other words, the hole 40 is completed by dry-etching or wet-etching the first focus electrode 36 and the second insulating layer 35 in a hole-to-hole form until the cathode electrode 32 is exposed.

As illustrated in FIG. 4C, the third insulating layer 37 and the second focus electrode 38 are formed on the first focus electrode 36. More specifically, the third insulating layer 37 is patterned to remain only in an edge of a sub-pixel region formed with the electron emitter 39 through a photoresist process after applying an insulating substance on the substrate 11 formed with the first focus electrode 36. Here, a plurality of electron emitters 39 are formed on one sub-pixel region. On the third insulating layer 37, the second focus electrode 38 made of a metal substance is formed. The second focus electrode 38 is not formed on the respective electron emitters 39 and is formed in a hole-to-slit structure formed in one sub-pixel unit. The second focus electrode 38 controls a vertical or horizontal beam spot of electrons emitted from the electron emitter 39.

Next, as illustrated in FIG. 4D, the electron emitter 39 is formed inside the hole 40. First, a portion of the cathode electrode 32 is exposed at the bottom of the hole 40 by applying a photoresist PR on the entire surface of the resultant product and then patterning it. A carbon nano tube (CNT) paste having photosensitivity is applied on the resultant product by the screen printing method. Regions of the CNT paste are selectively exposed by irradiating UV from the rear of the substrate 31. At this time, only the exposed region among the CNT paste regions is exposed by the photoresist PR pattern for curing.

When controlling exposure, the depth of the CNT paste can be controlled. Then, when removing the photoresist PR using developer such as acetone, etc., the unexposed CNT paste together with the photoresist PR is removed so that only the exposed site of the CNT paste remains to form the electron emitter 39. Subsequently, if a burning process is made at a predetermined temperature, for example, the temperature of approximately 460° C., the electron emitter 39 has a desired height by contracting concurrently with being burned.

At this time, the burning temperature can be varied depending on kinds and components of the CNT pastes. The height of the electron emitter 39 is approximately 2 μm to 4 μm when the first and second insulating layers are formed by the thick film process and approximately 0.5 μm to 1 μm when the first and second insulating layers are formed by the thin film process.

With the description as above, by forming two focus electrodes, the electron emission device having the focus electrode according to the above described embodiments capable of controlling a focusing of electrons and vertical and horizontal beam spots is completed.

Although a few examples of embodiments of the present invention have been shown and described, it would be appreciated by those skilled in the art that changes might be made to these embodiments without departing from the principles and spirit of the invention, the scope of which is defined in the accompanying claims and their equivalents.

What is claimed is:

1. An electron emission device, comprising:
a cathode electrode formed by depositing a conductive substance on a substrate;
a first insulating layer formed to expose a portion of the cathode electrode by applying an insulating substance on the cathode electrode;
a gate electrode formed by depositing a metal substance on the first insulating layer;
a second insulating layer formed of an insulating substance on the gate electrode;
a first focus electrode formed of a metal substance on the second insulating layer;
a third insulating layer formed of an insulating substance on a region of the first focus electrode;
a second focus electrode formed of a metal substance on the third insulating layer; and
an electron emitter formed in a region on which the portion of the cathode electrode is exposed.

2. The electron emission device according to claim 1, wherein the region of the first focus electrode on which the third insulating layer is formed is predetermined.

3. The electron emission device according to claim 1, wherein the first focus electrode is formed in a hole-to-hole structure and the second focus electrode is formed in a hole-to-slit structure.

4. The electron emission device according to claim 1, wherein a voltage at the first focus electrode is 0V or more to control a focusing of electrons and horizontal and vertical beam spots that are emitted from the electron emitter.

5. The electron emission device according to claim 1, wherein a voltage at the second focus electrode is 0V or less to control a shield of an electric field from an anode and horizontal or vertical beam spots emitted from the electron emitter.

6. A fabrication method of an electron emission device having a focus electrode, comprising:
forming a cathode electrode on a substrate;
forming a first insulating layer by applying an insulating substance on the cathode electrode after forming the cathode electrode on the substrate;
forming a gate electrode on the first insulating layer;
forming a second insulating layer by applying an insulating substance on the gate electrode after forming the gate electrode on the first insulating layer;
forming a first focus electrode on the second insulating layer;
forming a third insulating layer and a second focus electrode in a predetermined region after forming the first focus electrode on the second insulating layer;
forming a hole in the first insulating layer to expose a portion of the cathode electrode in a region; and
forming an electron emitter in the region in which the cathode electrode is exposed.
